(19) United States
(12) Patent Application Publication
(10) Pub. No.: US 2025/0019238 A1
(43) Pub. Date: Jan. 16, 2025

(54) METHOD FOR PRODUCING LITHIUM SULFIDE

(71) Applicant: AGC Inc., Tokyo (JP)

(72) Inventors: Hidenobu SEKI, Tokyo (JP); Norifumi OMORI, Tokyo (JP); Seiji HIGASHI, Tokyo (JP); Ryota ANDO, Tokyo (JP)

(73) Assignee: AGC Inc., Tokyo (JP)

(21) Appl. No.: 18/898,828

(22) Filed: Sep. 27, 2024

Related U.S. Application Data
(63) Continuation of application No. PCT/JP2023/013442, filed on Mar. 30, 2023.

(30) Foreign Application Priority Data
Apr. 7, 2022 (JP) 2022-064100

(51) Int. Cl. C01B 17/22

(52) U.S. Cl. CPC C01B 17/22; C01P 2004/60

(57) ABSTRACT

A method for producing lithium sulfide includes placing a powder containing a lithium element into a container, and while the container is sealed, vibrating the container from an outside to move the powder and reacting the powder with a gas comprising a sulfur element. The method may include temporarily reducing a pressure in the container in the middle of the reaction to lower than a pressure in the container at the time of the reaction, or reducing a pressure in the container after the reaction to lower than the pressure in the container at the time of the reaction.

### CROSS-REFERENCE TO RELATED APPLICATIONS

This is a bypass continuation of International Patent Application No. PCT/JP2023/013442, filed on Mar. 30, 2023, which claims priority to Japanese Patent Application No. 2022-064100, filed on Apr. 7, 2022. The contents of these applications are hereby incorporated by reference in their entireties.

### TECHNICAL FIELD

The present invention relates to a method for producing lithium sulfide.

### BACKGROUND ART

Lithium sulfide is known as, for example, a raw material of a solid electrolyte used in all-solid-state lithium-ion secondary batteries.

As a method for producing lithium sulfide, for example, a method for reacting a substance (powder) containing a lithium element such as lithium hydroxide with a gas containing a sulfur element such as hydrogen sulfide is known.

For example, Patent Literature 1 describes a method for producing lithium sulfide including synthesizing lithium sulfide by reacting lithium hydroxide with a gaseous sulfur source, and describes that a fluidized bed allows a solid-gas reaction to occur.

Patent Literature 2 describes that lithium sulfide particles are produced by bringing a reaction gas into contact with particulate lithium hydroxide to react a hydrogen sulfide gas with lithium hydroxide. Here, a configuration of laying particulate lithium hydroxide on a surface of a porous sheet is described as a configuration of disposing lithium hydroxide inside a reaction tank.

Patent Literature 3 describes a method for producing lithium sulfide by reacting a lithium raw material with a hydrogen sulfide gas to continuously produce lithium sulfide, and describes that a rotary kiln may be used as a reaction tank.

Patent Literature 4 describes an apparatus for lithium sulfide production, which includes a reaction container in which a lithium hydroxide powder is in contact with a hydrogen sulfide gas, and a stirring blade inside the reaction container.

Patent Literature 5 describes a method for producing lithium sulfide including reacting lithium hydroxide with hydrogen sulfide in a disk dryer without using a solvent.

### CITATION LIST

### Patent Literature

Patent Literature 1: JPH09-278423A
Patent Literature 2: JP2016-150859A
Patent Literature 3: JP2018-35045A
Patent Literature 4: WO2016/098351
Patent Literature 5: JP2017-222567A

### SUMMARY OF INVENTION

### Technical Problem

When lithium sulfide is produced, for example, when a substance (powder) containing the lithium element, such as lithium hydroxide, is reacted with the gas containing the sulfur element, such as hydrogen sulfide, water may be produced as a by-product. Here, in the methods described in Patent Literatures 1 and 2, in order to cause particles of the substance containing the lithium element to flow, a gas flow rate equal to or greater than a flow initiation velocity is required, which may result in poor gas usage efficiency. Furthermore, water may tend to aggregate on a wall surface of an apparatus with a slow gas flow rate, and when the powder is scattered by the gas, the powder tends to adhere to the wall surface of the apparatus. If the powder easily adheres to an inside of the apparatus, maintenance costs tend to increase.

In the method described in Patent Literature 3, an entire apparatus is rotated at a relatively slow speed, so that a powder is likely to adhere to a wall surface of the apparatus as water aggregates. Further, when the rotary kiln is used, a powder filling rate is relatively low, which may result in poor production efficiency. Furthermore, since a space not filled with the powder is also filled with a gas, a proportion of the gas that does not contribute to the reaction tends to be high, and gas usage efficiency may be poor.

In the methods described in Patent Literatures 4 and 5, the gas is likely to leak from a shaft of the stirring blade, which may result in poor gas usage efficiency. Further, when a toxic gas is used, a countermeasure against the leakage of the gas is required, and thus a cost on the equipment is likely to increase. In addition, in a portion of the apparatus where there is no stirring blade, adhesion of the powder caused by water aggregation is likely to occur.

Therefore, an object of the present invention is to provide a method for producing lithium sulfide having excellent productivity.

### Solution to Problem

That is, the present invention relates to the following 1 to 8.

1. A method for producing lithium sulfide, including:
placing a powder containing a lithium element into a container; and
while the container is sealed, vibrating the container from an outside to move the powder and reacting the powder with a gas containing a sulfur element.

2. The method for producing lithium sulfide according to the 1, including temporarily reducing a pressure in the container in the middle of the reaction to lower than a pressure in the container at the time of the reaction, or reducing a pressure in the container after the reaction to lower than the pressure in the container at the time of the reaction.

3. The method for producing lithium sulfide according to the 1 or 2, in which the pressure in the container at the time of the reaction is 0.100 MPa or more.

4. The method for producing lithium sulfide according to the 3, in which when a pressure in the container is reduced to lower than the pressure in the container at the time of the reaction, the pressure is less than 0.100 MPa.

5. The method for producing lithium sulfide according to the 1 or 2, including introducing the gas containing the sulfur element into the container from a nozzle disposed in the container, in which a jet position of the gas containing the sulfur element in the nozzle is within 50% of a height of a gas phase and within 50% of a depth of the powder, with respect to a surface of the powder.

6. The method for producing lithium sulfide according to the 1 or 2, in which the powder has an average particle diameter of 200 μm or more.

7. The method for producing lithium sulfide according to the 1 or 2, further including placing particles other than the powder containing the lithium element into the container.

8. The method for producing lithium sulfide according to the 1 or 2, in which an amplitude of the vibration is 1 mm to 10 mm.

### Advantageous Effects of Invention

According to the present invention, a method for producing lithium sulfide having excellent productivity can be provided.

### BRIEF DESCRIPTION OF DRAWINGS

FIG. 1 is a flowchart illustrating a method for producing lithium sulfide according to the present embodiment.

FIG. 2A and FIG. 2B show diagrams schematically illustrating the method for producing lithium sulfide according to the present embodiment. FIG. 2A is a schematic cross-sectional view of a side surface of a container during a reaction. FIG. 2B is a schematic cross-sectional view of a front surface of the same container as FIG. 2A.

FIG. 3 is a flowchart illustrating the method for producing lithium sulfide according to the present embodiment.

FIG. 4A and FIG. 4B show diagrams schematically illustrating the method for producing lithium sulfide according to the present embodiment. FIG. 4A is a schematic cross-sectional view of a side surface of a container during the reaction. FIG. 4B is a schematic cross-sectional view of a front surface of the same container as FIG. 4A.

FIG. 5 is a flowchart illustrating the method for producing lithium sulfide according to the present embodiment.

FIG. 6A and FIG. 6B show flowcharts illustrating the method for producing lithium sulfide according to the present embodiment. FIG. 6A is a flowchart illustrating a method including temporarily lowering, in the middle of the reaction, a pressure in the container lower than a pressure in the container at the time of the reaction. FIG. 6B is a flowchart illustrating a method including lowering, after the reaction, the pressure in the container lower than the pressure in the container at the time of the reaction.

### DESCRIPTION OF EMBODIMENTS

Hereinafter, the present invention is described in detail, but the present invention is not limited to the following embodiments, and can be freely modified and implemented without departing from the gist of the present invention. In addition, “to” indicating a numerical range is used to include numerical values written before and after it as a lower limit value and an upper limit value.

A method for producing lithium sulfide according to the present embodiment (hereinafter also referred to as the present production method) includes: placing a powder containing a lithium element into a container; and while the container is sealed, vibrating the container from an outside to move the powder and reacting the powder with a gas containing a sulfur element.

The present production method includes reacting the powder containing the lithium element with the gas containing the sulfur element. Hereinafter, the “powder containing a lithium element” and the “gas containing a sulfur element” may be simply referred to as a “powder” and a “gas”, respectively.

Examples of the powder containing the lithium element include lithium hydroxide, lithium carbonate, and lithium oxide, and it is preferable that the powder contains lithium hydroxide from the viewpoint of being able to be treated at a low temperature. Further, the gas containing the sulfur element includes a gas containing a component containing the sulfur element, and examples thereof include a gas containing one or more selected from the group consisting of hydrogen sulfide and carbon bisulfide as the component containing the sulfur element. Among these, the gas containing the hydrogen sulfide is preferred from the viewpoint of ease of handling since the gas containing the sulfur element is in a gaseous state at room temperature and normal pressure.

For example, a reaction between lithium hydroxide and hydrogen sulfide is represented by the following reaction formula (1). In this case, lithium hydroxide (LiOH) and hydrogen sulfide (H₂S) react with each other to produce lithium sulfide (Li₂S), and water (H₂O) is produced as a by-product.

2LiOH+H₂S→Li₂S+2H₂O (1)

The above reaction is typically a reaction in which solid lithium sulfide and water vapor are generated by the reaction between hydrogen sulfide gas and solid lithium hydroxide. For example, this reaction can be carried out by contacting hydrogen sulfide gas with solid lithium hydroxide, followed by heating.

When the powder containing the lithium element contains lithium hydroxide, it is possible to use either lithium hydroxide anhydride or lithium hydroxide monohydrate as the lithium hydroxide, or a mixture thereof. When lithium hydroxide monohydrate is used, from the viewpoint of improving reaction efficiency, it is preferable to previously heat-treat lithium hydroxide monohydrate to remove crystallization water. The heat treatment may be performed in a vibration container for synthesizing lithium sulfide or may be performed by another apparatus.

The present production method includes: placing the powder containing the lithium element into the container; and while the container is scaled, vibrating the container from an outside to move the powder and reacting the powder with a gas containing a sulfur element. That is, the present production method includes performing the reaction between the powder and the gas described above in a sealed container while vibrating the container from the outside to move the powder in the container.

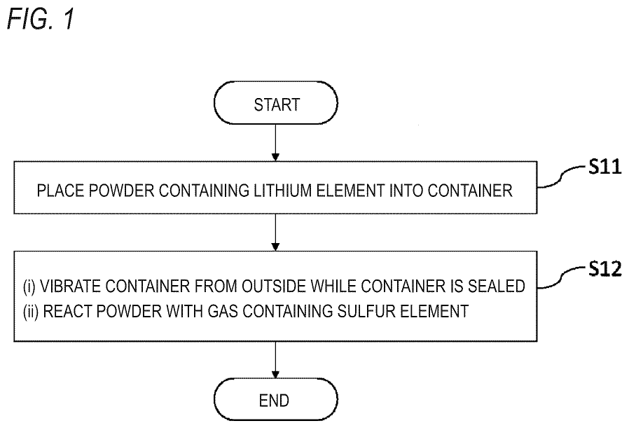

FIG. 1 is a flowchart illustrating the present production method. The production method illustrated in FIG. 1 includes step S11 of placing a powder containing a lithium element into a container, and step S12 including (i) vibrating the container from outside while the container is sealed and (ii) reacting the powder with a gas containing a sulfur element. That is, in step S12, the container is vibrated from the outside to move the powder while the container is sealed, and the powder is reacted with the gas containing the sulfur element.

As illustrated above, in a reaction between the powder containing the lithium element and the gas containing the sulfur element, water (water vapor) may be generated as a by-product. When such moisture is aggregated in the reaction container, the powder is more likely to adhere to an inside of the container due to the aggregated moisture, resulting in increased maintenance cost. On the other hand, in the present production method, the container itself is vibrated from the outside during the reaction, so that a part to which the powder may adhere is vibrated, thereby preventing the adhesion of the powder. Accordingly, the maintenance cost can be reduced. Further, since the powder inside the container is moved by the vibration of the container, it is not required to fluidize the powder with the gas, and therefore no excessive gas flow rate is required. Accordingly, in the present production method, use efficiency of the gas is enhanced. In the present production method, since it is not necessary to provide the container with a member which is likely to cause gas leakage, such as a rotating mechanism or a rotary shaft of a stirring blade, the container is sealed. Accordingly, the gas used for the reaction is less likely to leak, and the use efficiency of the gas is excellent. Furthermore, since the present production method is a method capable of providing a force for causing the powder to flow more efficiently in a vertical direction, a filling rate of the powder in the container can be relatively increased, and production efficiency of lithium sulfide is excellent.

In the present production method, vibrating the container from the outside means, for example, vibrating the container by vibrating a member such as a vibrator that is provided outside the container and in direct or indirect contact with the container.

Further, in the present production method, the state where the container is sealed refers to a state where there is no portion where the gas leaks, except openings formed in the intended manner such as an introducing inlet for introducing the powder containing the lithium element, a gas introducing inlet for introducing the gas containing the sulfur element, a gas discharging outlet for discharging the gas to be discharged after the reaction, and a discharging outlet for the lithium sulfide powder synthesized after the reaction. The container in the present production method does not include a member such as a rotary shaft of a stirring blade.

In the present production method, the prevention of the adhesion of the powder inside the container means both preventing the adhesion of the powder containing the lithium element to the inside of the container and preventing the adhesion of the lithium sulfide powder obtained by the reaction.

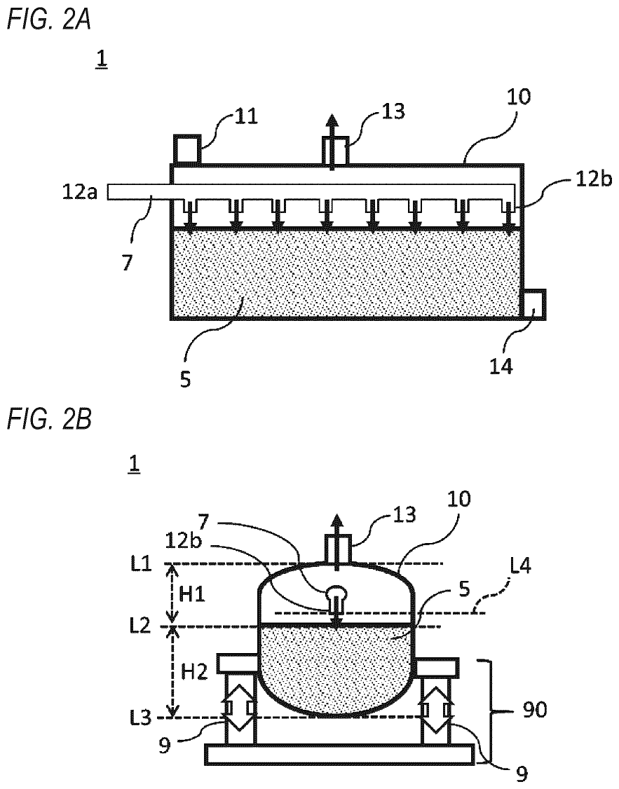

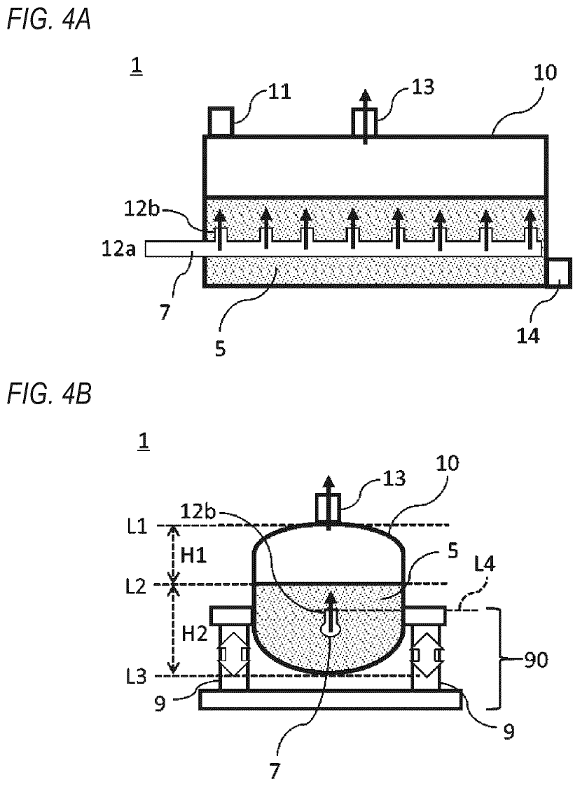

FIG. 2A and FIG. 2B are diagrams schematically illustrating the present production method. FIG. 2A is a schematic cross-sectional view of a side surface of the container during the reaction, and FIG. 2B is a schematic cross-sectional view of a front surface of the same container as FIG. 2A. Some members are shown only in FIG. 2A or FIG. 2B for convenience, and is omitted in FIG. 2B or FIG. 2A, and the same applies to FIG. 4A and FIG. 4B to be described later. In FIG. 2A or FIG. 2B and FIG. 4A and FIG. 4B to be described later, arrows indicated by solid black lines schematically represent a direction of a gas flow. In FIG. 2A or FIG. 2B, a production apparatus 1 includes a container 10, and the container 10 includes therein a powder 5 containing a lithium element.

A method for placing the powder containing the lithium element into the container is not particularly limited. Examples thereof include a method in which a container is provided with an openable portion such as a raw material inlet, and a raw material is introduced from the openable portion, and a method in which a powder containing a lithium element is introduced as a powder fluid together with an air flow. In the example of FIG. 2A, the container 10 includes a powder material introducing inlet 11. For example, the powder 5 containing the lithium element is placed in the container 10 from the powder material introducing inlet 11.

A filling amount of the powder containing the lithium element in the container is preferably 30% by volume to 100% by volume, more preferably 50% by volume to 90% by volume, and still more preferably 70% by volume to 80% by volume, relative to a volume of the container. Here, from the viewpoint of increasing the production efficiency of lithium sulfide by relatively increasing a processing amount per unit time, the filling amount is preferably 30% by volume or more, more preferably 50% by volume or more, and still more preferably 70% by volume or more, relative to the volume of the container. On the other hand, from the viewpoint of improving homogeneity of the reaction and of causing the powder to stably flow, the filling amount is preferably 100% by volume or less, more preferably 90% by volume or less, and still more preferably 80% by volume or less.

After the powder containing the lithium element is placed in the container, while the container is sealed, the container is vibrated from the outside to move the powder, and the powder is reacted with the gas containing the sulfur element. The method for sealing the container is not particularly limited. Examples thereof include using a container that does not include a member including a rotary shaft such as a stirring blade, and using a container made of a gas-impermeable material.

The method for vibrating the container is not particularly limited. In the configuration of FIG. 2B, the container 10 can be vibrated from the outside by disposing the container 10 on a pedestal 90 including vibrators 9 and vibrating the vibrators 9. At this time, the container is vibrated such that the powder in the container moves (flows) due to the vibration. For example, in the configuration of FIG. 2B, when the container 10 is disposed on the pedestal 90 including the vibrators 9 and the container 10 is vibrated from the outside by vibrating the vibrators 9, the powder in the container may flow so as to rotate in the container when viewed from an orientation in FIG. 2B, that is, when viewed from the front. In the configuration of FIG. 2B, the vibrator 9 is vibrated in a direction of void arrows in FIG. 2B, that is, in the vertical direction in FIG. 2B. Such an apparatus that can vibrate includes a vibration drying apparatus, and examples thereof include a VH vibration dryer and a VHC vibration dryer manufactured by CHUOKAKOHKI Co., Ltd.

A configuration example of the vibration drying apparatus is described below. The vibration dryer has a configuration in which, for example, a generally cylindrical drying container including a heating jacket attached to almost an entire surface, is arranged with an axial direction of a cylinder generally parallel to a horizontal direction, and is supported by a spring. A vibration source (vibrator) is attached to a bottom of the drying container. When a powder and grain raw material is charged into the drying container and the vibration source is operated in a circular motion in a circumferential direction, a powder and grain layer is given a motion that mainly moves in the vertical direction around the circumference. The drying container can supply heat to the powder and grain layer from a container wall surface by supplying steam, hot water, or temperature-controlled oil to the heating jacket.

In the present production method, an amplitude of the vibration is preferably 1 mm to 10 mm, more preferably 1.5 mm to 7 mm, and still more preferably 2 mm to 4 mm. Here, the amplitude is preferably 1 mm or more, more preferably 1.5 mm or more, and still more preferably 2 mm or more, from the viewpoint of causing the powder to sufficiently flow. On the other hand, the amplitude is preferably 10 mm or less, more preferably 7 mm or less, and still more preferably 4 mm or less, from the viewpoint of ease of manufacturing the apparatus. The amplitude of the vibration refers to a width of displacement in a vertical direction (direction along the vibration) of a container.

A frequency of the vibration is preferably 10 Hz to 100 Hz, more preferably 15 Hz to 80 Hz, and still more preferably 20 Hz to 60 Hz. Here, the frequency is preferably 10 Hz or more, more preferably 15 Hz or more, and still more preferably 20 Hz or more from the viewpoints of causing the powder to sufficiently flow and stabilizing the flow. On the other hand, the frequency of the vibration is preferably 100 Hz. or less, more preferably 80 Hz. or less, and still more preferably 60 Hz or less, from the viewpoint of ease of manufacturing the apparatus. The frequency of the vibration refers to the number of times of reciprocation in which a container is vibrated up and down (in a direction along the vibration) per second.

The container is vibrated from the outside in the state where the container is sealed in this manner to move the powder, and the powder is reacted with the gas. When the reaction is performed, for example, as shown in FIG. 2A and FIG. 2B, the gas containing the sulfur element can be introduced into the container 10 from a nozzle 7 disposed in the container 10. The nozzle 7 in FIG. 2A and FIG. 2B is disposed so as to continue from the outside of the container to the inside of the container, and is provided with a gas introducing inlet 12a on the outside of the container and a gas jet outlet 12b on the inside of the container. The nozzle 7 is fixed in the container. However, the method for introducing the gas containing the sulfur element into the container is not limited thereto. Further, the container 10 may be provided with a mechanism for discharging the gas in the container 10, together with a mechanism for introducing the gas containing the sulfur element. For example, in the configuration of FIG. 2A and FIG. 2B, the container 10 includes a gas discharging outlet 13.

The gas containing the sulfur element may be any gas containing a component containing the sulfur element as described above. When the gas containing the sulfur element is introduced into the container, a concentration of the component containing the sulfur element may be adjusted by further containing an inert gas or the like. Examples of the inert gas include a nitrogen gas and an argon gas. The concentration of the component containing the sulfur element in the gas containing the sulfur element (concentration of the gas containing the sulfur element) is preferably 20% by volume or more, more preferably 50% by volume or more, and still more preferably 80% by volume or more, from the viewpoint of sufficiently reacting the powder with the gas.

When the powder and the gas are reacted, the inside of the container is preferably heated to an appropriate temperature. Specifically, a temperature at which the powder and the gas are reacted is preferably 140° C. to 240° C., more preferably 160° C. to 230° C., and still more preferably 180° C. to 220° C. Here, the temperature is preferably 140° C. or higher, more preferably 160° C. or higher, and still more preferably 180° C. or higher from the viewpoints of allowing the reaction to proceed sufficiently and preventing the generated moisture from condensing. On the other hand, such a temperature is preferably 240° C. or lower, more preferably 230° C.′ or lower, and still more preferably 220° C. or lower from the viewpoint of heat resistance of the member. A heating method is not particularly limited, and may be a known method such as a method using a heating jacket described above.

A time for which the powder and the gas are reacted is not particularly limited because the time varies depending on conditions such as a pressure inside a container, a concentration of the gas containing the sulfur element, and a filling amount of the powder. As an example, the time is preferably 10 minutes to 600 minutes, more preferably 30 minutes to 300 minutes, and still more preferably 60 minutes to 180 minutes. Here, from the viewpoint of allowing the reaction to proceed sufficiently, the time for which the powder and the gas are reacted is preferably 10 minutes or more, more preferably 30 minutes or more, and still more preferably 60 minutes or more. On the other hand, the reaction time is preferably 600 minutes or less, more preferably 300 minutes or less, and still more preferably 180 minutes or less, from the viewpoint of production tact.

A pressure inside the container during the reaction between the powder and the gas is not particularly limited, but a normal pressure or a slight pressure is preferred, and a slight pressure is more preferred. Specifically, the pressure is preferably 0.100 MPa to 0.200 MPa, more preferably 0.105 MPa to 0.200 MPa, still more preferably 0.110 MPa to 0.160 MPa, and particularly preferably 0.120 MPa to 0.140 MPa. Here, by relatively increasing the pressure inside the container, the reaction between the powder and the gas can be more easily promoted. Specifically, the pressure inside the container during the reaction is preferably 0.100 MPa or more, more preferably 0.105 MPa or more, still more preferably 0.110 MPa or more, and particularly preferably 0.120 MPa or more. On the other hand, from the viewpoint of ease of manufacturing the apparatus, the pressure inside the container during the reaction is preferably 0.200 MPa or less, more preferably 0.160 MPa or less, and still more preferably 0.140 MPa or less.

The powder containing the lithium element used in the reaction preferably has an average particle diameter of, for example, about 100 μm to 1500 μm, more preferably 200 μm to 1000 μm, still more preferably 250 μm to 800 μm, and particularly preferably 300 μm to 800 μm. Here, the average particle diameter is preferably 100 μm or more, more preferably 200 μm or more, still more preferably 250 μm or more, and particularly preferably 300 μm or more. When the average particle diameter is equal to or greater than the lower limit value, the powder tends to flow stably when the container is vibrated. This allows the powder and the gas to react more homogenously. Further, since stagnation of the flow inside the container is prevented, the moisture is less likely to aggregate inside the container, and the adhesion of the powder to the inside of the container can be prevented. Furthermore, since the average particle diameter is relatively large, the powder is less likely to scatter, and the adhesion of the powder to the inside of the container is prevented. On the other hand, from the viewpoint of increasing the reaction efficiency, the average particle diameter is more preferably 1500 μm or less, still more preferably 1000 μm or less, and particularly preferably 800 μm or less.

Here, the average particle diameter of the powder containing the lithium element refers to a median diameter (D50) determined from a chart of a volume-based particle size distribution obtained by measuring a particle size distribution using a laser diffraction particle size distribution analyzer MT 3300 EXII manufactured by Microtrac.

D90 of the powder containing a lithium element is preferably 300 μm to 3000 μm, more preferably 500 μm to 2500 μm, and still more preferably 800 μm to 2000 μm. Here, D90 is preferably 300 μm or more, more preferably 500 μm or more, and still more preferably 800 μm or more. When D90 is equal to or greater than the lower limit value, the powder tends to flow stably when the container is vibrated. This allows the powder and the gas to react more homogenously. Further, since stagnation of the flow inside the container is prevented, the moisture is less likely to aggregate inside the container, and the adhesion of the powder to the inside of the container can be prevented. Furthermore, when D90 is equal to or greater than the lower limit value, the powder is less likely to scatter, and the adhesion of the powder to the inside of the container is prevented. On the other hand, in order to prevent unreacted particles from remaining, D90 is preferably 3000 μm or less, more preferably 2500 μm or less, and still more preferably 2000 μm or less.

Here, D90 refers to a value of D90 determined from a chart of a volume-based particle size distribution obtained by measuring a particle size distribution using a laser diffraction particle size distribution analyzer MT 3300 EXII manufactured by Microtrac.

An angle of repose of the powder containing the lithium element is preferably 50° or less, more preferably 45° or less, and still more preferably 40° or less. In general, the larger the average particle diameter of the powder, the smaller the angle of repose of the powder tends to be. That is, when the angle of repose is equal to or less than the above value, the powder tends to flow stably when the container is vibrated. This allows the powder and the gas to react more homogenously. Further, since stagnation of the flow inside the container is prevented, the moisture is less likely to aggregate inside the container, and the adhesion of the powder to the inside of the container can be prevented. Furthermore, since the average particle diameter is relatively large, the powder is less likely to scatter, and the adhesion of the powder to the inside of the container is prevented. Here, the angle of repose of the powder refers to a value measured by JIS R 9301-2-2: 1999, for example.

The present production method may further include placing a medium into the container. Examples of the medium include particles other than a powder containing a lithium element, and at least one of alumina particles and zirconia particles is preferred from the viewpoint of being less reactive with the gas containing the sulfur element and the powder containing the lithium element. By placing the medium into the container, the powder tends to flow stably when the container is vibrated. This allows the powder and the gas to react more homogenously. Further, since stagnation of the flow inside the container is prevented, the moisture is less likely to aggregate inside the container, and the adhesion of the powder to the inside of the container can be prevented. A timing of placing the medium into the container is not particularly limited, and may be, for example, before the powder and the gas are reacted.

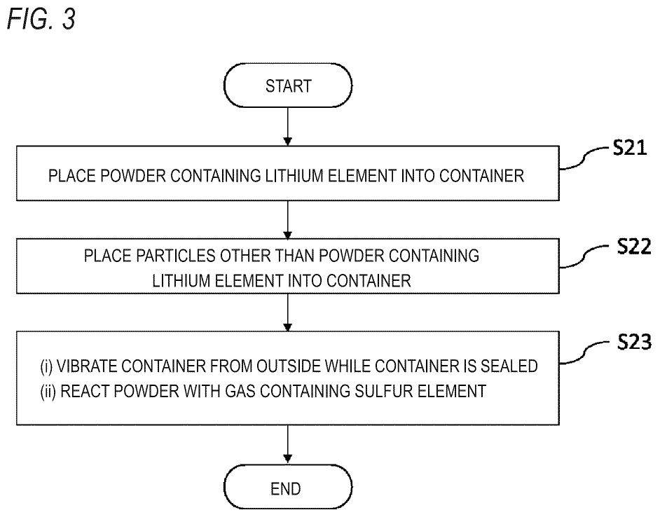

FIG. 3 is a flowchart illustrating the present production method when the particles (medium) other than the powder containing the lithium element are placed into the container. In this case, the present production method includes, for example, step S21 of placing the powder containing the lithium element into the container, step S22 of placing the particles other than the powder containing the lithium element into the container, and step S23 including (i) vibrating the container from the outside while the container is sealed and (ii) reacting the powder and the gas containing the sulfur element. Step S21 and step S22 may be performed in this order, or step S21 may be performed after step S22. Further, steps S21 and S22 may be performed in parallel or simultaneously.

When the gas containing the sulfur element is introduced into the container from the nozzle disposed in the container, a jet position L4 of the gas containing the sulfur element in the nozzle is preferably within 50% of a height H1 of a gas phase and within 50% of a depth H2 of the powder with respect to a surface L2 of the powder. The jet position L4 of the gas being within 50% of a height H1 of the gas phase with reference to the surface L2 of the powder means the following. That is, this means that in the case where the jet position L4 of the gas in the nozzle 7 is not buried in a layer of the powder 5 but is located in the gas phase as shown in FIG. 2, a distance from the surface L2 of the powder 5 to the jet position L4 of the gas is within 50% of the height H1 of the gas phase. Here, the surface L2 of the powder refers to a height of a surface of the powder when the powder in the container is leveled in a state where the container is not vibrated. Further, the height H1 of the gas phase refers to a distance from the surface of the powder to an uppermost surface in the container, and refers to a distance H1 from L2 to L1 in FIG. 2B and FIG. 4B to be described later.

FIG. 4A and FIG. 4B are diagrams schematically illustrating the present production method, and illustrate an example in which only the position of the nozzle 7 is changed from the configuration of FIG. 2A and FIG. 2B. In FIG. 2A, FIG. 2B, FIG. 4A, and FIG. 4B, common members and configurations are denoted by the same reference numerals in some places.

FIG. 4A is a schematic cross-sectional view of the side surface of the container during the reaction, and FIG. 4B is a schematic cross-sectional view of the front surface of the same container as FIG. 4A. The jet position L4 of the gas being within 50% of the depth H2 of the powder with respect to the surface L2 of the powder means that in the case where the jet position L4 of the gas in the nozzle 7 is in contact with or buried in the layer of powder 5 as shown in FIG. 4B, the distance from the surface L2 of the powder 5 to the jet position L4 of the gas is within 50% of the depth H2 of the powder. Here, a depth of the powder refers to a distance from the surface L2 of the powder to an inner lowest surface of the container, and in FIG. 2B and FIG. 4B, the depth of the powder refers to a distance H2 from L2 to L3.

The jet position of the gas is preferably within 50% of the height of the gas phase, more preferably within 40%, and still more preferably within 30%. Accordingly, the moisture in the container is efficiently discharged after the reaction.

Further, the jet position of the gas is preferably within 50% of the depth of the powder, more preferably within 40%, and still more preferably within 30%. Accordingly, it is possible to prevent the moisture produced during the reaction from causing a reverse reaction in the container and inhibiting the production reaction of lithium sulfide. Further, it is possible to prevent the gas flow from stagnation and prevent the moisture from aggregating in the container. When the gas containing the sulfur element is introduced into the container from the nozzle disposed in the container, the jet position of the gas containing the sulfur element in the nozzle is preferably within a height of ±100 mm, more preferably within ±80 mm, and still more preferably within ±60 mm with respect to the surface of the powder. Accordingly, the moisture in the container is efficiently discharged after the reaction. Further, it is possible to prevent the moisture generated during the reaction from causing the reverse reaction in the container and inhibiting the generation reaction of lithium sulfide. Further, it is possible to prevent the gas flow from stagnation and prevent the moisture from aggregating in the container.

Here, a + direction of the height with respect to the surface of the powder refers to a direction proceeding from a surface of a powder to a gas phase side (that is, an upper side of a container) in a height direction of the powder layer. On the other hand, a − direction refers to a direction proceeding from the surface of the powder to a side in which the powder layer is located (that is, a bottom side of the container) in the height direction of the powder layer. For example, with respect to the surface L2 of the powder, an upward direction on the paper of FIG. 2B and FIG. 4B is the + direction of the height, and a downward direction on the paper of FIG. 2B and FIG. 4B is the − direction of the height.

Since the jet position of the gas is preferably 50% or less of the depth of the powder, when the depth of the powder is 200 mm or more, it is particularly preferable to be located within a height of ±100 mm from the surface of the powder.

It is preferable that a plurality of gas jet positions are disposed in the container. Accordingly, the gas containing the sulfur element can be more easily supplied evenly over a wider area in the container, and the reaction between the powder and the gas can be more easily carried out homogeneously and efficiently. FIG. 2A, FIG. 2B, FIG. 4A, and FIG. 4B respectively illustrate configurations in which the nozzle 7 includes a plurality of gas jet outlets 12b and the gas is jetted from a plurality of positions of the nozzle 7. That is, in FIG. 2A, FIG. 2B, FIG. 4A, and FIG. 4B, the plurality of gas jet positions are disposed in the container. Further, a jetting direction of the gas from each jet position is preferably directed toward the surface of the powder (the surface of the powder layer).

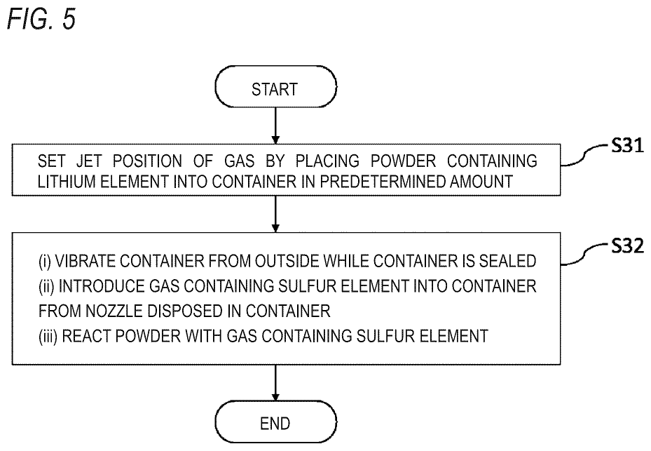

FIG. 5 is a flowchart illustrating the present production method in the case where the gas containing the sulfur element is introduced into the container from the nozzle disposed in the container, and the jet position of the gas containing the sulfur element in the nozzle is set to the predetermined position as described above. In this case, the present production method includes, for example, step S31 of setting the jet position of the gas by placing the powder containing the lithium element into a container in a predetermined amount, and step S32 including (i) vibrating the container from the outside while the container is sealed, (ii) introducing the gas containing the sulfur element into the container from the nozzle disposed in the container, and (iii) reacting the powder with the gas containing the sulfur element. It is preferable that the gas flow in the container is prevented from sediment or stagnation. By preventing the sediment or the stagnation in the gas flow, the moisture is less likely to aggregate inside the container, and the adhesion of the powder to the inside of the container can be prevented. Examples of the method for preventing the sediment or the stagnation include making the powder flow more stably during the reaction, as described above.

By reacting the powder containing the lithium element with the gas containing the sulfur element in this manner, lithium sulfide is obtained as a solid.

In the present production method, it is preferable to remove the moisture in the container during or after the reaction between the powder and the gas. By removing the moisture in the container, the adhesion of the powder to the inside of the container can be prevented.

Examples of the method for removing the moisture in the container include temporarily reducing a pressure in the container in the middle of the reaction between the powder and the gas to lower than a pressure in the container at the time of the reaction, or reducing a pressure in the container after the reaction between the powder and the gas to lower than a pressure in the container at the time of the reaction. The above method is referred to as a temporary depressurization step. By reducing the pressure in the container to lower than the pressure in the container at the time of the reaction by the temporary depressurization step, the gas containing the moisture can be discharged from the mechanism for discharging the gas in the container. The gas is discharged through the gas discharging outlet 13 provided in the container 10. At this time, the gas containing the sulfur element remaining after the reaction may also be discharged. In the present production method, the pressure in the container is easily adjusted by using a sealable container. Even in the case where the moisture is removed by temporarily reducing the pressure in the container in the middle of the reaction to lower than the pressure in the container at the time of the reaction, the gas containing the sulfur element can be supplied into the container in parallel by relatively increasing a gas discharging amount.

Specifically, when the pressure in the container is reduced to lower than the pressure in the container at the time of the reaction, the pressure is preferably 0.010 MPa to 0.100 MPa, more preferably 0.010 MPa or more and less than 0.100 MPa, still more preferably 0.020 MPa to 0.080 MPa, and particularly preferably 0.030 MPa to 0.060 MPa. That is, it is preferable to set the pressure in the container to 0.100 MPa or less, more preferably less than 0.100 MPa, still more preferably 0.080 MPa or less, and particularly preferably 0.060 MPa or less temporarily in the middle of the reaction between the powder and the gas, or after the reaction between the powder and the gas. On the other hand, the pressure in the container after the reaction is preferably 0.010 MPa or more, more preferably 0.020 MPa or more, and still more preferably 0.030 MPa or more, from the viewpoint of the production tact.

A difference between the pressure at the time of the reaction between the powder and the gas and the pressure after the reaction is preferably 0.005 MPa to 0.100 MPa, more preferably 0.010 MPa to 0.080 MPa, and still more preferably 0.020 MPa to 0.060 MPa. Here, the difference of the pressure is preferably 0.005 MPa or more, more preferably 0.010 MPa or more, and still more preferably 0.020 MPa or more from the viewpoint of effectively discharging the gas containing the moisture. On the other hand, the difference between the pressure at the time of the reaction and the pressure after the reaction is preferably 0.100 MPa or less, more preferably 0.080 MPa or less, and still more preferably 0.060 MPa or less from the viewpoint of the production tact.

When the moisture in the container is removed, it is preferable to prevent the sediment or the stagnation in the gas flow, as in the case of the reaction. Accordingly, the moisture is less likely to aggregate inside the container, and the adhesion of the powder to the inside of the container can be prevented.

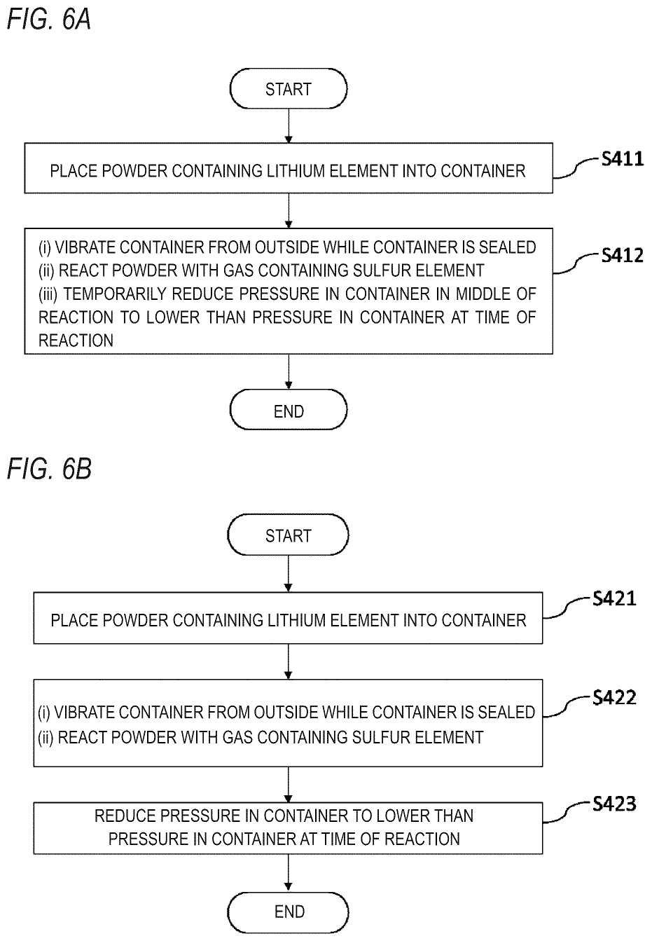

FIG. 6 shows flowcharts illustrating examples of the present production method in the case where the method includes removing the moisture in the container. FIG. 6A is a flowchart illustrating a method including temporarily reducing the pressure in the container in the middle of the reaction to lower than the pressure in the container at the time of the reaction. FIG. 6B is a flowchart illustrating the method including reducing the pressure in the container after the reaction to lower than the pressure in the container at the time of the reaction. That is, the production method illustrated in FIG. 6A includes: step S411 of placing the powder containing the lithium element into the container; and step S412 including (i) vibrating the container from the outside while the container is sealed, (ii) reacting the powder with the gas containing the sulfur element, and (iii) temporarily reducing the pressure in the container in the middle of the reaction to lower than the pressure in the container at the time of the reaction. The production method illustrated in FIG. 6B includes: step S421 of placing the powder containing the lithium element into the container; step S422 including (i) vibrating the container from the outside while the container is sealed, and (ii) reacting the powder with the gas containing the sulfur element; and step S423 of reducing the pressure in the container to lower than the pressure in the container at the time of the reaction. In addition, in the present production method, an aspect in which FIG. 6A and FIG. 6B are combined may also be used. For example, in the production method in FIG. 6A, a step similar to step S423 in FIG. 6B may be further provided after step S412.

The gas containing the sulfur element used in the reaction may be reused by being recovered or circulated in the apparatus. This can further improve efficiency of using the gas containing the sulfur element.

After the reaction between the powder and the gas, preferably, after the moisture in the container is removed, lithium sulfide is recovered from the container. The recovery may be carried out by a known method, but it is preferable to carry out a recovery operation in an environment where lithium sulfide is not exposed to air, for example, in an inert gas atmosphere. The container 10 shown in FIG. 2A, FIG. 2B, FIG. 4A, and FIG. 4B includes a powder material discharging outlet 14. For example, lithium sulfide after the reaction can be recovered through such a powder material discharging outlet.

The recovered lithium sulfide can be identified by, for example, X-ray diffraction measurement.

The present production method may be performed in a batch manner or a continuous manner. Even in the case of performing in a continuous manner, by dividing into appropriate sections, it is possible to appropriately adjust the pressure while sealing the container, for example by lowering the pressure to remove the moisture in the container after the reaction. For example, a batch reaction can be performed in a VH vibration dryer manufactured by CHUOKAKOHKI Co., Ltd., and a continuous reaction can be performed in a VHC vibration dryer.

Lithium sulfide obtained by the present production method is preferably used as a raw material of a solid electrolyte used in an all-solid-state lithium ion secondary battery, a raw material of a positive electrode active material, a raw material of a negative electrode active material, an intermediate raw material of a chemical, and the like.

As described above, the following matters are disclosed in the present description.

1. A method for producing lithium sulfide, including:
placing a powder containing a lithium element into a container; and
while the container is sealed, vibrating the container from an outside to move the powder and reacting the powder with a gas containing a sulfur element.

2. The method for producing lithium sulfide according to the 1, including temporarily reducing a pressure in the container in the middle of the reaction to lower than a pressure in the container at the time of the reaction, or reducing a pressure in the container after the reaction to lower than the pressure in the container at the time of the reaction.

3. The method for producing lithium sulfide according to the 1 or 2, in which the pressure in the container at the time of the reaction is 0.100 MPa or more.

4. The method for producing lithium sulfide according to the 3, in which when a pressure in the container is reduced to lower than the pressure in the container at the time of the reaction, the pressure is less than 0.100 MPa.

5. The method for producing lithium sulfide according to any one of the 1 to 4, including introducing the gas containing the sulfur element into the container from a nozzle disposed in the container, in which a jet position of the gas containing the sulfur element in the nozzle is within 50% of a height of a gas phase and within 50% of a depth of the powder, with respect to a surface of the powder.

6. The method for producing lithium sulfide according to any one of the 1 to 5, in which the powder has an average particle diameter of 200 μm or more.

7. The method for producing lithium sulfide according to any one of the 1 to 6, further including:
placing particles other than the powder containing the lithium element into the container.

8. The method for producing lithium sulfide according to any one of the 1 to 7, in which an amplitude of the vibration is 1 mm to 10 mm.

### EXAMPLES

Hereinafter, the present invention is described in detail with reference to Examples, but the present invention is not limited thereto.

Examples 1 to 8 are all Working Examples.

### Example 1

A lithium hydroxide powder (manufactured by Tokyo Chemical Industry Co., Ltd.) was placed in a vibration drying apparatus (product name: VH-10, manufactured by Chuo Kakohki Co., Ltd.). An average particle diameter (D50) of the lithium hydroxide powder was 400 μm, and D90 was 1000 μm. The powder was added to the reaction container until the powder reached a height that was 50% of a height from a bottom to a top of the container. After the adding, the vibration of the vibration drying apparatus was started at an amplitude of 3 mm and a vibration frequency of 24 Hz. Under these vibration conditions, it was found that the powder was stably rotated and moved.

Next, an atmosphere in the reaction container was evacuated from a gas discharging outlet by using a vacuum pump, and a pressure in the reaction container was set to 0.005 MPa. Thereafter, nitrogen was introduced from a gas introducing inlet, and an inside of the reaction container was set to a nitrogen atmosphere. A flow rate of nitrogen introduced through the gas introducing inlet was set to 1 standard litter min (SLM), and the pressure in the reaction container was adjusted such that the pressure in the container was 0.105 MPa. While maintaining the gas flow rate and the pressure, a jacket temperature covering a periphery of the reaction container was raised to 200° C. After the temperature was reached, the gas introduced from the gas introducing inlet was switched to 0.5 SLM nitrogen and 0.5 SLM hydrogen sulfide, and the reaction between lithium hydroxide and hydrogen sulfide was started.

The pressure in the reaction container at the time of the reaction was adjusted to 0.105 MPa. A position of the gas jet outlet was set based on a powder surface, that is, was set to 25% of a height of a gas phase from a powder surface layer to the top of the container. The gas flowed for 4 hours. Thereafter, the introduced gas was switched to 1 SLM of nitrogen and kept for 1 hour, after which heating was stopped, the temperature was returned to room temperature, the vibration was stopped, and a sample was recovered.

A reaction rate of recovered lithium sulfide was measured by powder X-ray diffraction (XRD) measurement to be described later, and found to be 94%. After the recovery, a wall surface of the container was inspected for adhesion, but no adhesion was found, and a next batch test could be started.

### Example 2

In (Example 1), the reaction with the gas was continued for 4 hours, but in this example, lithium sulfide was synthesized in the same manner except that first, the gas was allowed to flow for 2 hours to react, then the introduction of the gas was stopped temporarily and the pressure in the reaction container was set to 0.020 MPa (temporary depressurization step), after which the gas was introduced again to set the pressure in the reaction container to 0.105 MPa and the reaction with the gas was further continued for 2 hours.

A reaction rate of recovered lithium sulfide was found to be 99%. After the recovery, a wall surface of the container was inspected for adhesion, but no adhesion was found, and a next batch test could be started.

### Example 3

Lithium sulfide was synthesized in the same manner as in (Example 1), except that the pressure in the reaction container at the time of the reaction with the gas, which was 0.105 MPa in (Example 1), was set to 0.120 MPa.

A reaction rate of recovered lithium sulfide was found to be 96%. After the recovery, a wall surface of the container was inspected for adhesion, but no adhesion was found, and a next batch test could be started.

### Example 4

Lithium sulfide was synthesized in the same manner as in (Example 1), except that lithium hydroxide used in (Example 1) was crushed in a mortar and classified to have an average particle diameter of 200 μm. Compared to (Example 1), there was some disturbance in rotational motion of the powder during the vibration, but it was still possible to synthesize lithium sulfide.

A reaction rate of recovered lithium sulfide was found to be 90%. After the recovery, a wall surface of the container was inspected for adhesion, but no adhesion was found, and a next batch test could be started.

### Example 5

Lithium hydroxide having an average particle diameter of 200 μm used in (Example 4) was mixed with the same weight of alumina particles as the medium. The used alumina particles had a diameter of 3 mm. Lithium sulfide was synthesized in the same manner as in (Example 1), except that this mixture was placed in the vibration drying apparatus as a powder material.

By adding the alumina particles as a medium, rotational motion of the powder, which was disturbed when vibrated in (Example 4), became a stable rotational flow. After the synthesis, the mixture of lithium sulfide and the alumina particles was collected, and the alumina particles were removed using a sieve to collect only lithium sulfide.

The reaction rate of recovered lithium sulfide was found to be 97%. After the recovery, a wall surface of the container was inspected for adhesion, but no adhesion was found, and a next batch test could be started.

### Example 6

Lithium sulfide was synthesized in the same manner as in (Example 1) except that in (Example 1), the gas jet outlet was positioned at 25% of a height of the gas phase from a powder surface layer position to a top of the container, but in this example, this position was at 50% of the height of the gas phase.

A reaction rate of recovered lithium sulfide was found to be 90%. After the recovery, a wall surface of the container was inspected for adhesion, but no adhesion was found, and a next batch test could be started.

### Example 7

Lithium sulfide was synthesized in the same manner as in (Example 1) except that in (Example 1), the gas jet outlet was positioned at 25% of the height of the gas phase from the position of the powder surface layer to the top of the container, but in this example, the gas jet outlet was buried in the powder at 25% of a powder layer thickness from a powder surface layer, that is, 25% of a depth of the powder.

A reaction rate of recovered lithium sulfide was found to be 95%. After the recovery, a wall surface of the container was inspected for adhesion, but no adhesion was found, and a next batch test could be started.

### Example 8

Lithium sulfide was synthesized in the same manner as in (Example 1) except that in (Example 1), the gas jet outlet was positioned at 25% of the height of the gas phase from the position of the powder surface layer to the top of the container, but in this example, the gas jet outlet was buried in the powder at 50% of a powder layer thickness from a powder surface layer, that is, 50% of a depth of the powder.

A reaction rate of recovered lithium sulfide was found to be 91%. After the recovery, a wall surface of the container was inspected for adhesion, but no adhesion was found, and a next batch test could be started.

From the above results, lithium sulfide could be synthesized at a reaction rate of 90% or more by synthesizing under an appropriate vibration condition. Further, after the synthesis, the raw material did not adhere to the wall surface of the reaction container, and thus the container could be directly used when a next batch was synthesized, thereby improving production efficiency.

In (Example 2), the reaction rate was higher than in (Example 1). This is considered to be because the pressure is reduced in the middle of the synthesis, thereby reducing the amount of water generated in the lithium sulfide synthesis reaction. The generated water causes a reverse reaction that converts lithium sulfide back to lithium hydroxide, which is considered to be the cause of the decrease in reaction rate. Therefore, it is considered that the reaction rate was increased by removing the water generated under reduced pressure in the middle of the reaction.

(Example 3) shows that the reaction rate to lithium sulfide can be increased by increasing the pressure at the time of the reaction.

In (Example 4), it was observed that when a fine-grained raw material was used, the rotational flow of the powder during vibration motion became unstable. Therefore, it is considered that there was unevenness in the powder reacting with the gas, and the reaction efficiency with lithium sulfide is somewhat reduced.

In (Example 5), the medium was added to stabilize the flow and the synthesis was performed. It is considered that the rotational flow which was instable in Example 4 was stabilized by adding the medium, which increased the reaction rate.

In (Example 6), the position of the gas jet outlet was changed. This indicates that the reaction efficiency may decrease if the gas jet position is far from the powder surface.

(Example 7) and (Example 8) are examples in which the gas jet outlets are embedded in the powder.

### (Calculation of Reaction Rate)

The reaction rate to lithium sulfide was determined by XRD measurement (device name: SmartLab manufactured by Rigaku Corporation). Specifically, first, separate from the analysis of the sample to be measured, a sample was measured in which lithium hydroxide was mixed with lithium sulfide to give a known mass percentage. Peak intensity of lithium hydroxide in the sample to be measured was compared with peak intensity of lithium hydroxide of a mixture obtained by mixing lithium sulfide with lithium hydroxide to give the known mass percentage, thereby calculating a mass percentage of lithium hydroxide contained in the sample to be measured.

The reaction rate to lithium sulfide was calculated as (100−mass % of lithium hydroxide) %.

TABLE 1

| | Average | Pressure | | | | Rotational | State in | |
|---|---|---|---|---|---|---|---|---|
| | particle | at time | | | | motion of | reaction | Reaction |
| | diameter | of | Temporary | | | powder | container | rate to |
| | (D50) | reaction | depressurization | Position of gas jet | | caused by | after | lithium |
| | μm | MPa | step MPa | outlet | Medium | vibration | synthesis | sulfide % |
| Example | 400 | 0.105 | None | At 25% of height of | None | Stable | Raw material did | 94 |
| 1 | | | | gas phase from | | | not adhere and | |
| | | | | powder surface layer | | | next batch was | |
| | | | | | | | started | |
| Example | 400 | 0.105 | 0.020 | At 25% of height of | None | Stable | Raw material did | 99 |
| 2 | | | | gas phase from | | | not adhere and | |
| | | | | powder surface layer | | | next batch was | |
| | | | | | | | started | |
| Example | 400 | 0.120 | None | At 25% of height of | None | Stable | Raw material did | 96 |
| 3 | | | | gas phase from | | | not adhere and | |
| | | | | powder surface layer | | | next batch was | |
| | | | | | | | started | |
| Example | 200 | 0.105 | None | At 25% of height of | None | Unstable | Raw material did | 90 |
| 4 | | | | gas phase from | | | not adhere and | |
| | | | | powder surface layer | | | next batch was | |
| | | | | | | | started | |
| Example | 200 | 0.105 | None | At 25% of height of | Alumina | Stable | Raw material did | 97 |
| 5 | | | | gas phase from | 3 mm φ | | not adhere and | |
| | | | | powder surface layer | | | next batch was | |
| | | | | | | | started | |
| Example | 400 | 0.105 | None | At 50% of height of | None | Stable | Raw material did | 90 |
| 6 | | | | gas phase from | | | not adhere and | |
| | | | | powder surface layer | | | next batch was | |
| | | | | | | | started | |
| Example | 400 | 0.105 | None | At 25% of depth of | None | Stable | Raw material did | 95 |
| 7 | | | | powder from powder | | | not adhere and | |
| | | | | surface layer | | | next batch was | |
| | | | | | | | started | |
| Example | 400 | 0.105 | None | At 50% of depth of | None | Stable | Raw material did | 91 |
| 8 | | | | powder from powder | | | not adhere and | |
| | | | | surface layer | | | next batch was | |
| | | | | | | | started | |

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-064100) filed on Apr. 7, 2022, the contents of which are incorporated herein by reference.

### REFERENCE SIGNS LIST

1 production apparatus
10 container
11 powder material introducing inlet
12a gas introducing inlet
12b gas jet outlet
13 gas discharging outlet
14 powder material discharging outlet
5 powder containing lithium element
7 nozzle
9 vibrator
90 pedestal

1. A method for producing lithium sulfide, comprising:
placing a powder comprising a lithium element into a container; and
while the container is sealed, vibrating the container from an outside to move the powder and reacting the powder with a gas comprising a sulfur element.

2. The method for producing lithium sulfide according to claim 1, comprising temporarily reducing a pressure in the container in the middle of the reaction to lower than a pressure in the container at the time of the reaction, or reducing a pressure in the container after the reaction to lower than the pressure in the container at the time of the reaction.

3. The method for producing lithium sulfide according to claim 1, wherein a pressure in the container at the time of the reaction is 0.100 MPa or more.

4. The method for producing lithium sulfide according to claim 3, wherein when a pressure in the container is reduced to lower than the pressure in the container at the time of the reaction, the pressure is less than 0.100 MPa.

5. The method for producing lithium sulfide according to claim 1, comprising introducing the gas comprising the sulfur element into the container from a nozzle disposed in the container, wherein a jet position of the gas comprising the sulfur element in the nozzle is within 50% of a height of a gas phase and within 50% of a depth of the powder, with respect to a surface of the powder.

6. The method for producing lithium sulfide according to claim 1, wherein the powder has an average particle diameter of 200 μm or more.

7. The method for producing lithium sulfide according to claim 1, further comprising placing particles other than the powder comprising the lithium element into the container.

8. The method for producing lithium sulfide according to claim 1, wherein an amplitude of the vibration is 1 mm to 10 mm.
